(19) United States
(12) Patent Application Publication
(10) Pub. No.: US 2017/0220644 A1
(43) Pub. Date: Aug. 3, 2017

(54) MEDIA DISCOVERY ACROSS CONTENT RESPOSITORY

(71) Applicant: HEWLETT PACKARD ENTERPRISE DEVELOPMENT LP, Houston, TX (US)

(72) Inventors: Ashok Chandnani, Pontiac, MI (US); Kevin E. Matthews, Pontiac, MI (US); Kirk Alan Kaufman, Pontiac, MI (US); Stephen Poehlein, Los Angeles, CA (US)

(73) Assignee: HEWLETT PACKARD ENTERPRISE DEVELOPMENT LP, Houston, TX (US)

(21) Appl. No.: 15/009,741

(22) Filed: Jan. 28, 2016

(51) Int. Cl. G06F 17/30; H04L 29/08

(52) U.S. Cl. CPC G06F 17/30522; H04L 67/10; H04L 67/02; G06F 17/30598

(57) ABSTRACT

A method of discovering media assets across a content repository is disclosed. Information of interest is gathered from activity on a social media site. The information of interest is analyzed to determine a selected topic. The content repository is searched for media assets related to the selected topic. The selected topic is aggregated with links to the media assets related to the selected topic from the content repository.

### BACKGROUND

Digital media assets are used in several industries including entertainment, marketing and advertising in consumer and retail sectors, healthcare, education, and government. Digital media assets—which can include images, audio, video, animations, documents, and other visually rich files—are often managed and accessed from departmental Digital Asset Management systems, which can also go by the names of Media Asset Management, Brand Resource Management, Entertainment Media Asset Management, Marketing Content Management systems, and others. Digital Asset Management systems often include at least one or more of the functionalities of a repository having version control, categorization, and upload and download services, a metadata index that includes descriptors, administrative data, and information on relationships, an access and rights subsystem, and a workflow or collaboration engine. Due to the popularity of blogs, social networking, and the Internet to distribute and consume content, various public systems, including social media sites, and others are also used to create and store digital assets.

### BRIEF DESCRIPTION OF THE DRAWINGS

FIG. 1 is a block diagram illustrating an example method of the disclosure.

FIG. 2 is a schematic diagram illustrating an example system for use with the method of FIG. 1.

FIG. 3 is a block diagram illustrating an example feature of the method of FIG. 1.

FIG. 4 is a block diagram illustrating an example feature of the method of FIG. 1.

FIG. 5 is a schematic diagram illustrating an example computing device that can be used to implement the method of FIG. 1 and the system of FIG. 2.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The disclosure relates to systems and methods that analyze activity on social media to develop criteria to search content repositories for media assets. Social media activity of interest is monitored, and selected topics are determined from the activity of interest. The selected topics are applied to execute searches for related media assets across one or more content repositories. Results from the search are presented with distributions across repositories or across identified selected topics and repositories such that the assets can be accessed. In one example, assets in public and private content repositories are organized and presented according to what is trending in social media related to selected events and activities as well as user sentiment about the selected events and activities. The systems and methods can provide an intersecting view of available media assets related to popular topics in current social media activity.

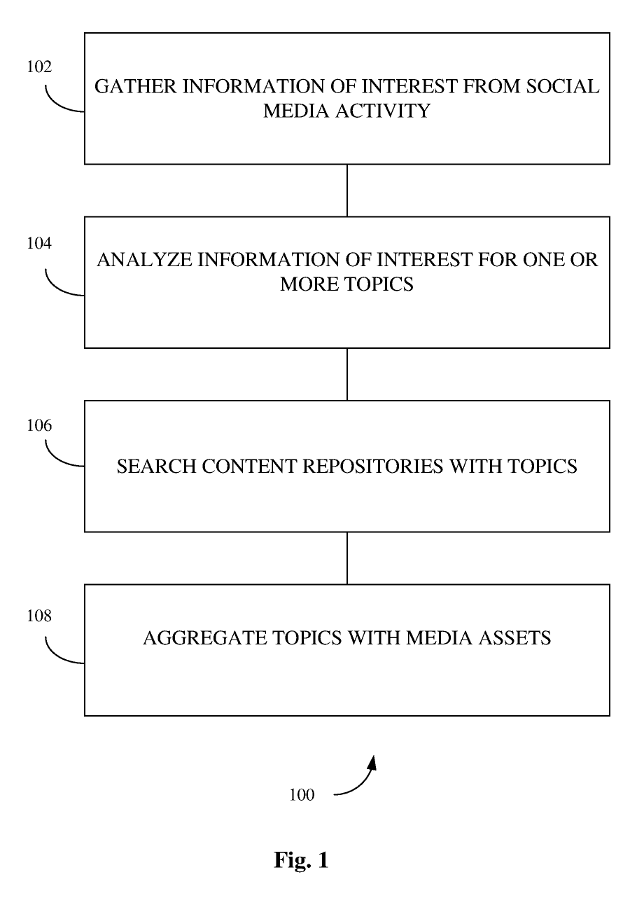

FIG. 1 illustrates an example method 100 of discovering media assets across a content repository. In one example, methods 100 can be implemented as a combination of hardware and programming to discover media assets across a content repository. Information of interest is gathered from activity on a social media site at 102. The information of interest is analyzed to determine a selected topic, such as a popular topic or a sentiment, at 104. The content repository is searched for media assets related to the selected topic at 106. The selected topic is aggregated with links to the media assets related to the selected topic from the content repository at 108. In one example, the method can be implemented as computer readable medium for storing computer executable instructions for controlling a computing device. In another example, a system can include a processor and memory configured to perform the method. The system can work as a stand-alone asset management product or service or with other management or discovery tools.

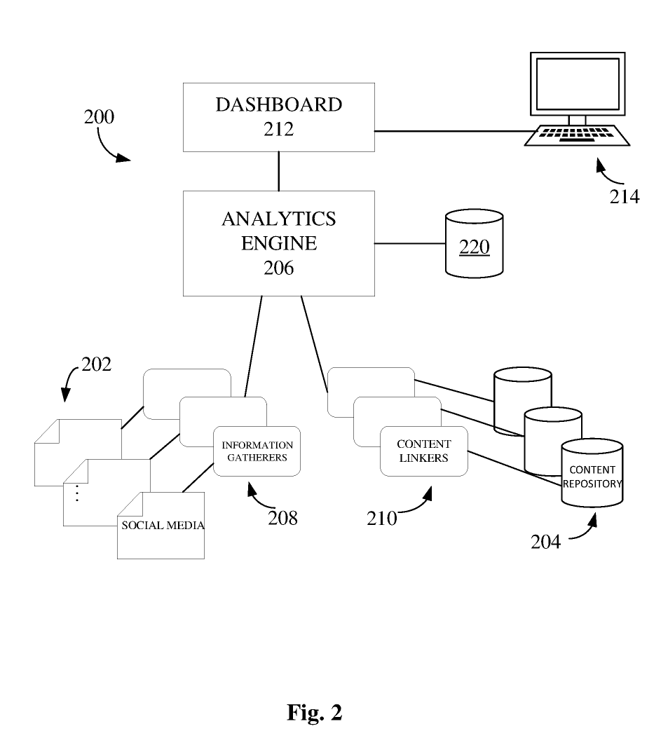

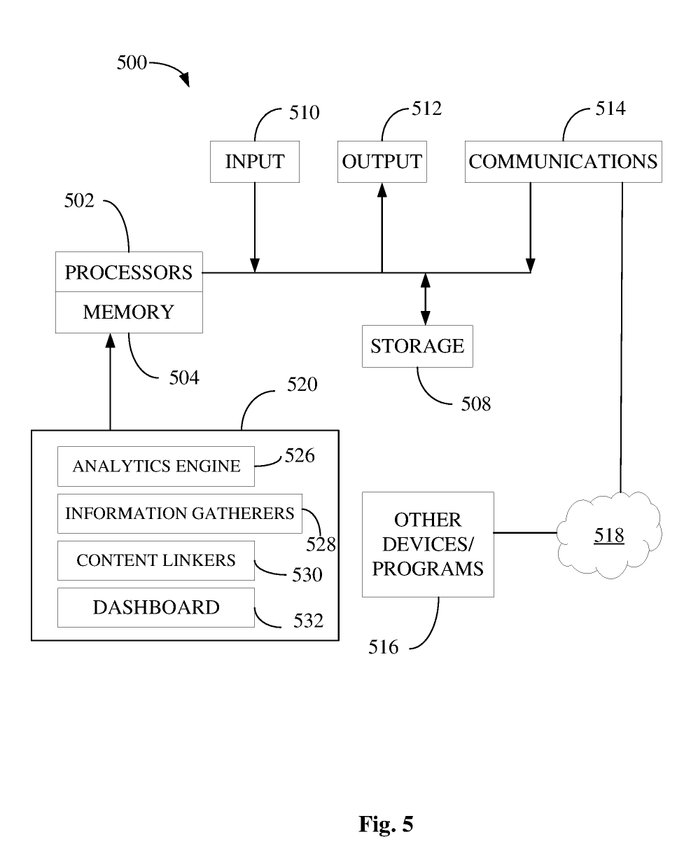

FIG. 2 illustrates an example system 200 that can be employed to implement method 100 and determine selected topics from activity on social media sites 202 to discover media across one or more content repositories 204. An example system 200 can be implemented as a combination of hardware and programming such as in the examples illustrated and described in FIG. 5 below. System 200 includes an analytics engine 206 having a database 220, information gatherers 208, content linkers 210, and dashboard 212 The analytics engine 206 receives information of interest via one or more information gathers 208 configured to receive data from social media sites 202. The analytics engine 206 performs the analysis on the received data to determine selected topics, such as popular topics, topics having a positive sentiment, topics of interest to the user, or other topics or combinations of topics. One or more content linkers 210 search content repositories 204 for media assets related to the selected topics. The discovered media assets related to the selected topics are aggregated with links and other organization features in a dashboard 212 that is presented to a user via a user interface 214 such as a user's desktop, laptop, mobile device, or other computing device.

Analytics engine 206, database 220, information gathers 208, content linkers 210, and dashboard 212 to implement method 100 and other methods of the disclosure, e.g., methods 300, 400 described below, may be any combination of hardware and programming to implement the functionalities of the example system and methods. Such combinations of hardware and programming may be implemented in a number of different ways. For example, the programming for the system 200 and methods 100, 300, 400 may be processor executable instructions stored on at least one non-transitory machine-readable storage medium, and the hardware for the system 200 may include at least one processing resource to execute those instructions. In some examples, the hardware may also include other electronic circuitry to at least partially implement at least one feature of system 200 and methods 100, 300, 400. In some examples, the at least one machine-readable storage medium, such as a memory device, may store instructions that, when executed by the at least one processor, at least partially implement some or all features of system 200 and some or all of methods 100, 300, 400. In such examples, system 200 may include the at least one machine-readable storage medium storing the instructions and the at least one processing resource to execute at least one of the methods 100, 300, 400. In other examples, the functionalities of any engines of system 200 and methods 100, 300, 400, may be at least partially implemented in the form of electronic circuitry.

Social media sites 202 can include one or more websites and applications, such as communication channels, that enable users to create, share, consume, and respond to social media. Forums, blogging and micro-blogging, social networking, social bookmarking, social curation (collaborative sharing of content), and wikis are examples of social media sites. Examples of activity on social media sites 202 includes creating, sharing, consuming social media by users of, or subscriber to, social media sites 202, and responding to social media activity of users by other users of, or subscribers to, social media sites are also examples of activity on the social media sites 202. Examples of social media sites are available under the trade designations Facebook, from Facebook, Inc., of Menlo Park, Calif., Twitter, from Twitter, Inc., of San Francisco, Calif. Facebook is a popular free social networking site that allows users to create profiles, upload media, post messages, and comment or otherwise respond to posts or other comments. Twitter is a popular micro-blogging service that allows users to broadcast user posts called “tweets” and to follow the tweets of other users (as reply to tweets with tweets). Posts are a particular example of activity on social media sites and can include a message comprising conversational text that can include characters, ideograms, and other indicia, as well as other data elements including a username or handle, date and time of the activity, geolocation of the activity, number of responses, and number of engagements with the activity.

Content repositories 204 maintain collections of media assets. In one example, media assets are classified and indexed so the assets can be retrieved and organized. Example of content repositories 204 for media assets include digital asset management systems or software applications such as one available under the trade designation MediaBin from Hewlett Packard, web-based or cloud-based content services such as from a site available under the trade designation YouTube from Google, Inc., of Menlo Park, Calif., Flikr from Yahoo, Inc., of Sunnyvale, Calif., Getty Images, of Seattle, Wash., and others, whether available to the public or with a subscription, and other proprietary repositories. Typically, metadata fields and taxonomies for searching and organizing content and assets are particular to each content repository 204. Further, content repositories 204 may analyze assets and harvest more information, such as speech and facial recognition, for richer search and retrieval methods.

Information gatherers 208 of system 200 monitor and receive information of interest from, for example, the conversational text and other data elements of activity on the social media sites 202. In one example, information gathers 208 are software tools that can be built using the native application program interfaces (APIs) of the social media sites 202. In this example, an information gatherer of the information gatherers 208 is generated to correspond with a social media source, such as an information gatherer built using the an API available from Twitter, Inc., to monitor and receive information from the Twitter micro-blogging service.

Examples of information of interest that is monitored can be defined in one or more keywords, key phrases, or other user definitions that can be stored, for example, in a configuration file of the information gatherer 208. Accordingly, each information gatherer of the information gatherers 208 can monitor and receive a mutually independent, overlapping, or identical set information of interest, such as keywords, with respect to the other information gatherers 208. The scope of information, fields, or data elements gathered from the activity on the social media site can be based on the scope of data the social media source exposes as part of the API. In one example, the information gatherers 208 can be configured to run on a defined schedule and can include traffic shaping techniques to control the rate of information received from the social media sites 202 delivered to the analytics engine 206.

Analytics engine 206 of system 200 provides management and analysis of possibly large volumes of structured or semi-structured data from the social media activity. In one example, an analytics portfolio is available under the trade designation Vertica from Hewlett-Packard Enterprise, the present assignee, incorporating columnar database storage technology. The analytics engine 206 creates and stores records from the received social media activity provided from the information gatherers 208. Further, the analytics engine 206 can include sentiment dictionaries and other tools to evaluate sentiment and popular topics or otherwise analyze the records or perform queries. The analytics engine 206 can be configured to run on premises with one or more of the content repositories 204, dashboard 212, and user interface, off premises, or as a service in a cloud infrastructure.

Content linkers 210 include mechanisms to provide media assets from the content repositories 204 associated with the selected topics determined from the analytics engine 206. Content linkers 210 can include retrieval tools configured to search the particular metadata fields of each content repository 204 for values that include the selected topics. Retrieval tools can be configured to correspond with the particular content repositories 204. For example, content linkers 210 can be built using the API of a content repository 204 to be accessed with the system 200. Content linkers 210 can also sort through the developed assets to remove multiple copies and associate the links or thumbnails corresponding with assets developed with the search into the database 220. For example, the content linkers can build a universal resource locator (URL) for the asset. If staging is desired and the developed asset has not been staged, such as if the content repository 204 including the asset does not provide a native URL based mechanism for viewing or accessing the asset, the content linker 210 can copy the asset to a staging area of the system 200, build a URL string to the staging area copy, and insert the URL string into the database 220. The URL, or other linking information, along with other information associated with the asset, is stored in the database 220 and made available to the dashboard 212.

Dashboard 212 can aggregate the selected topics with links to the media assets and other information associated with the assets. In one example, the dashboard 212 can include a set of views, charts, and tables for organizing and presenting information and records regarding the assets in the user interface 214. Information and records for the dashboard 212 can be stored in the database 220. The dashboard 212 can present information such as preview thumbnails of the asset, title of the asset, asset links, and source repository. The asset can be presented using native applications associated with the user interface 214.

System 200 can operate independently of the social media sites 202 and content repositories 204 such as in the background. For example, information gatherers 208 and content linkers 210 can interact with social media sites 202 and content repositories 204, respectively, with relatively small or negligible disruption or awareness of system 200.

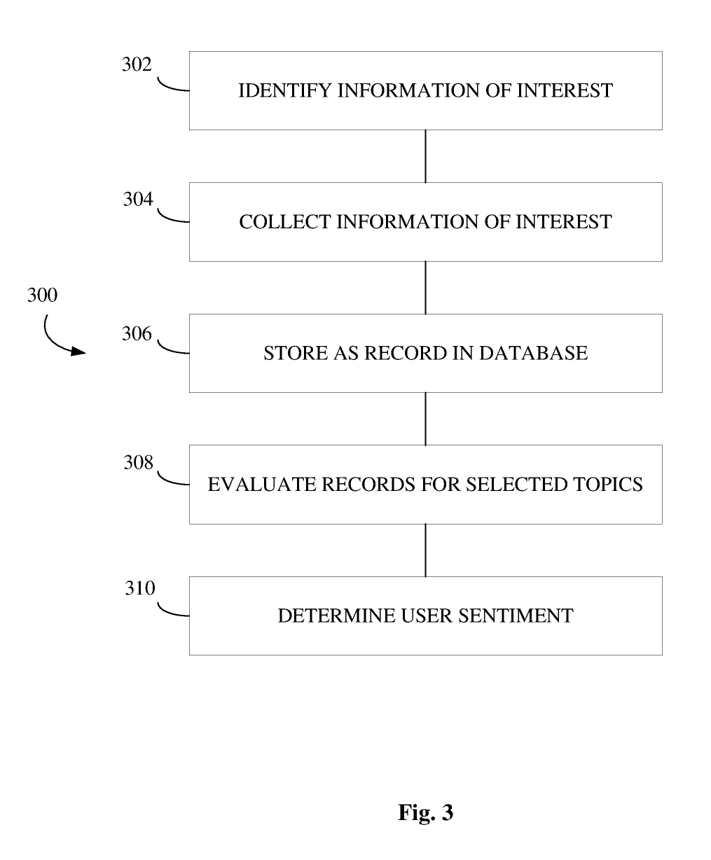

FIG. 3 illustrates an example method 300 to gather and analyze the information of interest from social media sites 202 to determine one or more selected topics for use in searching the content repositories 204. In one example, method 300 can be implemented as a combination of hardware and programming for controlling the system 200, such as in the examples illustrated and described in FIG. 5 below, to gather and analyze the information of interest. Information of interest to a user can be defined in one or more keywords at 302. Multiple keywords can be used to define a wide variety of categories for information of interest, such as each keyword can represent a separate and independent category of interest of the user. Alternatively, multiple keywords can be used to focus information of interest. Other configurations are possible. The keywords are used to pull information of interest from the social media activity at 304. For example, a social media activity may include a tweet with conversational text as well as other data elements. The keywords are applied to the conversational text and other data elements, depending on the configuration of the information of interest, to monitor and retrieve activity on the social media site including one or more of the keywords or defined information of interest.

The data retrieved at 304 can be stored in the database 220 as a record at 306. For example, the data stored in the record can be evaluated for one or more topics in the social media activity at 308 as part of the analysis at 104. In one example, topics include themes within the social media activity identified by the information of interest and are distinguishable from the information of interest. The topics can be evaluated and determined based on one or more rules. In one example, a rule used to evaluate topics is to find topics or items in the information records that occur more frequently than others to determine popular topics from the information of interest. In this example, the most popular themes in the information records can be listed based on the keyword used to gather the social media activity. In another example, a rule can be used to find social media posts developed from information of interest that related to a particular subject matter. In this example, information of interest may relate to a particular celebrity, and a topic can be selected to find social media posts related to a theme, such as cooking or fishing, within the gathered social media activity.

The information of interest can also be evaluated to determine user sentiment at 310 as part of an analysis at 104. For example, a sentiment score can be created for information of interest within the record based on positive or negative influence of surrounding sentiment-related words and the proximity of the sentiment-related words to the information of interest or topic in the conversational text. In one example, a sentiment score can be 1 for positive sentiment, 0 for neutral or no sentiment, and −1 for negative sentiment. Depending on the context of the social media activity, the topic can include a sentiment score based on other word associations and configurations of the sentiment dictionaries in the analytics engine 206. In one example, the sentiment score can be included for all topics, or where sentiment is included in the record; and the information of interest is evaluated for user sentiment at 310 in parallel with other analysis 104, such as in parallel with determining popular topics at 308. In another example, the analysis can be performed in series, such as popular topics are determined from topics having a positive (or negative) sentiment, or a sentiment score is provided to topics determined to be popular topics.

In one example of an application of method 300, an information gatherer 208 has been created to monitor information of interest from activity on Twitter including information of interest related to the disparate keywords “royal,” “crime,” “stock,” “election,” and “boxing” at 302 as,

TwitterExtractor.keywords=royal,crime,stock,election,boxing

A tweet has been detected that includes the word “election,” at 304 and is stored in the database 220 as a record including a record identifier and date and time along with the text of the tweet and other data elements at 306. For example,
created: 2016-01-15 23:27:49.0
id: 595792054173639868
text: XYZ has won the provincial election in ABC! Today is a great day.
   The record can be evaluated for topics at 308 using the analytics engine 206. Queries and analysis can determine the record includes the topic “day” as well as assigning a sentiment score of 1 at 310 to the topic because the word “great” was in close proximity to the topic “day.”

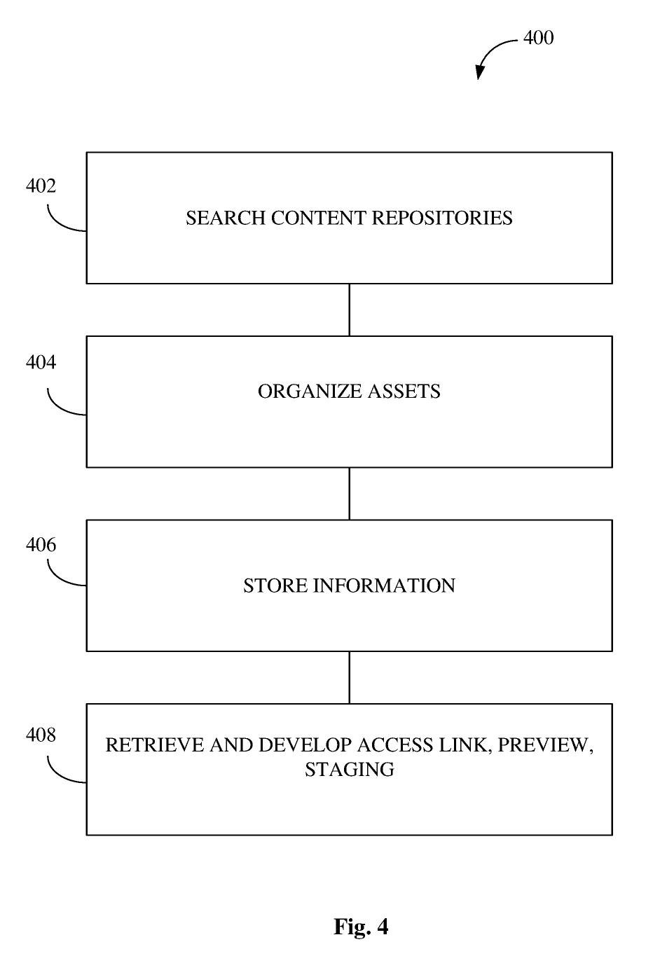

FIG. 4 illustrates an example method 400 to apply the selected topics from method 300 and develop media assets related to the selected topics from the content repositories 204. In one example, method 400 can be implemented as a combination of hardware and programming for controlling the system 200, such as in the examples illustrated and described in FIG. 5 below, to apply the selected topics. Method 400 can be implemented by content linkers 210 to develop assets consistent with the information collected with the information gatherers 208 and analyzed for selected topics. Each content repository is searched for media assets related to the selected topics at 402. In this respect, the content repositories are searched according to selected topics trending in social media or by user sentiment. In one example, a content linker 210 will cycle through the one or more selected topics searching the metadata fields of the content repository for values that include the selected topics. The developed assets are organized at 404. For example a list of assets related to the selected topics is compiled and pared to remove duplicate copies or other cumulative versions of the assets via an asset identifier. In addition to the assets, additional information related to the assets is retrieved from the content repository. The additional information can include asset access link (such as a URL), thumbnail preview link, repository identifier, asset title, and associated topic. The additional information is stored in the database 220 at 406, and can be applied in the dashboard 212. In some examples, the assets links can be further developed at 408 to provide for a preview of the assets, simplified retrieval and viewing of the assets, and staging in the dashboard 212.

FIG. 5 illustrates an example computer system that can be employed in an operating environment and used to host or run computer programming in the form of a computer application 520 implementing example method 100, and other methods of the disclosure, as included on one or more computer readable storage mediums storing computer executable instructions for controlling the computer system, such as a computing device, to perform a process. In one example, the computer system of FIG. 5 can be used to implement modules and associated tools of application 520 corresponding with system 200. For example, analytics engine 526 may implement the functionalities described above in relation to the analytics engine 206, information gatherers 528 may implement the functionalities described above in relation to the information gatherers 208, content linkers 530 may implement the functionalities described above in relation to the content linkers 210, and dashboard 532 may implement the functionalities described above in relation to the dashboard 212.

The exemplary computer system of FIG. 5 includes a computing device, such as computing device 500. Computing device 500 typically includes one or more processors 502 and memory 504 for storing and executing application 520. The processors 502 may include two or more processing cores on a chip or two or more processor chips. In some examples, the computing device 500 can also have one or more additional processing or specialized processors (not shown), such as a graphics processor for general-purpose computing on graphics processor units, to perform processing functions offloaded from the processor 502. Memory 504 may be arranged in a hierarchy and may include one or more levels of cache. Memory 504 may be volatile (such as random access memory (RAM)), non-volatile (such as read only memory (ROM), flash memory, etc.), or some combination of the two. The computing device 500 can take one or more of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 500 may also include additional storage 508. Storage 508 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. For example, application 520 can be stored in storage 808, and at least one or more components of application 520 can be loaded and stored into memory 504 for execution on processor 502. A propagating signal by itself does not qualify as storage media.

Computing device 500 often includes one or more input and/or output connections, such as USB connections, display ports, proprietary connections, and others to connect to various devices to receive and/or provide inputs and outputs. Input devices 510 may include devices such as keyboard, pointing device (e.g., mouse), pen, voice input device, touch input device, or other. Output devices 512 may include devices such as a display, speakers, printer, or the like. Computing device 500 often includes one or more communication connections 514 that allow computing device 500 to communicate with other computers/applications 516. Example communication connections can include, but are not limited to, an Ethernet interface, a wireless interface, a bus interface, a storage area network interface, a proprietary interface. The communication connections can be used to couple the computing device 500 to a computer network 518, which is a collection of computing devices and possibly other devices interconnected by communications channels that facilitate communications and allows sharing of resources and information among interconnected devices. Examples of computer networks include a local area network, a wide area network, the Internet, or other network.

Computing device 500 can be hosted in a cloud computing environment that includes one or more interconnected cloud computing nodes configured to communicate with local computing devices including user interface 214. Cloud computing environment includes features such as statelessness, low coupling, modularity, and semantic interoperability. Cloud computing nodes can be configured as computing devices including a processor, memory, storage, communication components, and software in the form of program modules stored in the memory. Cloud computing nodes may be grouped physically or virtually in one or more networks or in one or more cloud deployment models. The cloud computing environment offers services such as infrastructure, platforms, software, and business processes.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of discovering media assets across a content repository, comprising:
gathering information of interest from activity on a social media site;
analyzing the information of interest for a selected topic;
searching the content repository for media assets related to the selected topic; and
aggregating the selected topic with links to the media assets related to the selected topic from the content repository.

2. The method of claim 1 wherein gathering information of interest includes defining a keyword and monitoring the activity for the keyword.

3. The method of claim 1 wherein the selected topic is a popular topic.

4. The method of claim 1 comprising determining user sentiment from the activity.

5. A computer readable medium for storing computer executable instructions for controlling a computing device to perform a method of discovering media assets across a content repository, the method comprising:
gathering information of interest from activity on a social media site;
analyzing the information of interest for a selected topic;
searching the content repository for media assets related to the selected topic; and
aggregating the selected topic with links to the media assets related to the selected topic from the content repository.

6. The computer readable medium of claim 5 wherein aggregating the selected topic with links to the media assets includes staging the media assets.

7. A system to discover media assets across a content repository, comprising:
an information gatherer to gather social media activity based on information of interest from a conversational text of the social media activity on a social media site;
a content linker to search the content repository for media assets related to a selected topic; and
an analytics engine to evaluate the information of interest to determine the selected topic and aggregate the selected topic with links to the media assets related to the selected topic.

8. The system of claim 7 wherein the analytics engine includes a database.

9. The system of claim 8 wherein the information of interest is stored as a record in the database.

10. The system of claim 8 wherein searching includes developing media assets and providing links to the media assets.

11. The system of claim 8 wherein additional information corresponding with each media asset are stored in the database.

12. The system of claim 7 wherein the information of interest is distinguishable from the selected topic.

13. The system of claim 7 including a plurality of information gatherers to monitor and receive information corresponding with activity on a plurality of social media sites.

14. The system of claim 7 wherein the content linker is configured to search metadata fields particular to the content repository.

15. The system of claim 14 including a plurality of content linkers to search a plurality of content repositories.
